(19) United States
(12) Patent Application Publication
(10) Pub. No.: US 2009/0040238 A1
(43) Pub. Date: Feb. 12, 2009

(54) IMAGE DISPLAY PROGRAM AND STORAGE MEDIUM CONTAINING SAME

(76) Inventors: Mitsue ITO, Tokyo (JP); Wataru Ito, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/233,873

(22) Filed: Sep. 19, 2008

Related U.S. Application Data
(63) Continuation-in-part of application No. 11/256,927, filed on Oct. 25, 2005.

(30) Foreign Application Priority Data
Oct. 25, 2004 (JP) 2004-309269

(51) Int. Cl. G09G 5/00

(52) U.S. Cl. 345/660

(57) ABSTRACT

A program is to be executed by a computer having an image display apparatus. The program, when executed, causes the computer to perform the functions of displaying an initial image on the display apparatus; receiving a zoom-in boundary designated on the displayed initial image, the part of the displayed initial image surrounded by the zoom-in boundary being a target image to be enlarged; detecting a size of the zoom-in boundary; comparing the detected size of the zoom-in boundary with a reference size; if the detected size of the zoom-in boundary is smaller than the reference size, setting a middle boundary that defines a redefined image on the initial image, and enlarging the redefined image to display the enlarged redefined image on the display apparatus. The redefined image includes the entire part of the target image and a part of the initial image outside of the zoom-in boundary.

This application is a Continuation-In-Part Application of application Ser. No. 11/256,927 filed on Oct. 25, 2005, which is herein incorporated by reference.

### FIELD OF THE INVENTION

The present invention relates to an image display program and a storage medium containing same; and, more particularly, to an image display program and a storage medium containing the same for an easy operation of an enlargement setting.

### BACKGROUND OF THE INVENTION

Recently, an image display device using a graphical user interface (GUI), which is capable of displaying an image of a format such as JPEG and BMP, is broadly in use. For such an image display device, functions such as selecting an arbitrary image by using a mouse or a keyboard or enlarging the image into an arbitrary size have been investigated.

For example, when an operator selects an image, a designated range of the selected image is enlarged to be displayed on a screen (hereinafter, main window). In order to show which part of the selected image the displayed range corresponds to, a reduced whole image of the selected image is displayed on another screen, hereinafter, to be called as a sub window, and the enlarged range is indicated on the reduced image by a frame. Here, in the whole image displayed in the sub window, the range of enlargement may be changed by controlling a size and a position of the frame by using an input device such as a mouse or a keyboard.

Referring to FIG. 12, an exemplary image enlargement display method will be described. FIG. 12 shows an exemplary operating screen 161 of the image display device which displays an image

The main window 171 and sub window 172 are displayed on the operating screen 161 of the image display device. The sub window 172 is located in the upper right side of the operating screen 161. The enlarged image of the selected image is displayed in the main window 171. In the sub window 172, the frame corresponding to the enlarged image displayed in the main window 171 is displayed on a reduced whole image such that it can be easily recognized to which part of the whole image the enlarged image displayed in the main window 171 corresponds.

The operator can move the zoom-in boundary 173 displayed in the sub window 172 and change the size of the frame by using the mouse such that enlargement range of the image displayed in the main window 171 can be changed.

However, the image display method for the image display device mentioned above has a problem as follows.

That is, in the above mentioned image display device, in order to show the enlargement range of the enlarged image on the whole image, the reduced whole image is displayed in the sub window 172, and the enlarged part is indicated with the zoom-in boundary 173. The enlargement range can be varied by using the zoom-in boundary 173. Because of this, when the designated enlargement ratio is high, the zoom-in boundary 173 becomes too small. Accordingly, it becomes difficult for the operator to confirm the enlargement range and to change the range.

Referring to FIG. 13 and FIG. 14, example of such a problem will be described hereinafter.

FIG. 13 illustrates an example of the operating screen 161 of the image display device, and shows an original image 181 that is used for enlargement and an enlargement range 182 on the original image 181.

On the operating screen 161, the main window 171, the sub window 172, and the zoom-in boundary 173 are provided. The original image 181 and the enlargement range 182 on the original image 181 are reduced and displayed in the sub window 172.

When the enlargement range 182 in the original image 181 is relatively large, in other words when the enlargement ratio is set to be relatively low, the size of the zoom-in boundary 173 is relatively large that the operator can easily manipulate with it to change the enlargement range without any difficulty.

FIG. 14 illustrates another example of the operating screen 161 of the image display device, and shows an original image 191 used in enlargement and an enlargement range 192 on the original image 191.

On the operating screen 161, the main window 171, the sub window 172, and the zoom-in boundary 173 are provided. The original image 191 and the enlargement range 192 on the original image 191 are reduced and displayed on the sub window 172.

However, in the FIG. 14, the zoom-in boundary 173 displayed on the sub window 172 is hardly recognizable. This is because, as shown in FIG. 14, the operator has set the enlargement ratio to be relatively high; in other words, the operator has set the enlargement range 192 to be too small. Accordingly, the zoom-in boundary 173 in the sub window 172 is displayed to be as small as one pixel. In this case, it is very difficult for the operator to check and change the enlargement range.

Moreover, even though the enlargement ratio is set to be high by using an original image 191 having very large number of pixels, the enlargement can be performed only up to one pixel of the reduced whole image displayed on the sub window 172, and a larger enlargement range thereof cannot be set, thereby degrading the precision of the enlargement.

### SUMMARY OF THE INVENTION

It is, therefore, an object of the present invention to provide an image display program facilitating an enlargement (zoom-in) of an image on a computer screen by displaying an image of a proper size to designate a position and range in an enlargement target image and a storage medium containing the same.

In accordance with an embodiment of the present invention, there is provided a program running on a computer constituting an image displaying apparatus, the program including the functions of:

(a) displaying a target image to be enlarged;

(b) enlarging a part of the displayed target image and displaying the enlarged part of the target image;

(c) receiving an enlarging range designated by an operator for the displayed part of the target image; and

(d) enlarging an image portion in the designated enlarging range for the displayed part of the target image and displaying the enlarged image portion,

wherein the functions of the program are achieved by the computer.

In accordance with another exemplary embodiment of the present invention, there is provided a program including the following functions of:

receiving an enlargement range designated by the operator for the displayed target image;

detecting a size of the enlargement range;

comparing the detected size of the enlargement range with a threshold value; and

wherein, in the function (b) of displaying the part of the target image, a partial image of the displayed target image is displayed when the detected size of the enlargement range is less than the threshold value, the displayed partial image containing therein the enlargement range.

In accordance with a still further embodiment of the present invention, in the function of displaying the part of the target image, a function (b1) of enlarging an image part of a currently displayed image and displaying the enlarged image part is carried out at least once with respect to a newly displayed image.

In addition, the function of receiving the enlarging range designated by the operator is carried out with respect to an image part maximally enlarged by the function (b1).

In accordance with a still further embodiment of the present invention, images generated by the functions (a) and (b), are simultaneously displayed in a single picture frame or printed on a single sheet of paper.

In another embodiment, one of the generated images are displayed in a single picture frame or printed on a single sheet of paper by switching said one of the generated images.

In addition, in a still another embodiment, one of the generated images are output in a single picture frame or printed on a single sheet of paper by choosing said one of the generated images as the one to be displayed.

In accordance with a still further embodiment, there is provided a program running on a computer constituting an image displaying apparatus, the program including the functions of:

(a) displaying a target image to be enlarged;

(b) receiving an enlarging range designated by an operator for the displayed part of the target image;

(c) detecting a size of the received enlarging range;

(d) comparing the detected size of the enlarging range with threshold value;

wherein when the detected enlarging range is less than the threshold value, a sub-window for displaying an image of a predetermined size larger than the received enlarging range is displayed, and a frame representing the received enlarging range is displayed in the displayed image of the predetermined size,

wherein the functions of the program are achieved by the computer.

A target image to be enlarged is displayed.

An enlarging range designated by an operator is received for the displayed part of the target image.

A size of the received enlarging range is detected.

The detected size of the enlarging range is compared with threshold value.

In accordance with another aspect of the present invention, there is provided a storage medium containing a program running on a computer constituting an image displaying apparatus, the program including the functions of:

(a) displaying a target image to be enlarged;

(b) enlarging a part of the displayed target image and displaying the enlarged part of the target image;

(c) receiving an enlarging range designated by an operator for the displayed part of the target image; and

(d) enlarging an image portion in the designated enlarging range for the displayed part of the target image and displaying the enlarged image portion,

wherein the functions of the program are achieved by the computer.

In accordance with a further embodiment of a storage medium of the present invention, the storage medium containing another program running on a computer constituting an image displaying apparatus is provided. Here, the program includes the following functions.

A target image to be enlarged is displayed.

An enlarging range designated by an operator is received for the displayed part of the target image.

A size of the received enlarging range is detected.

The detected size of the enlarging range is compared with threshold value.

Here, when the detected enlarging range is less than the threshold value, a sub-window for displaying an image of a predetermined size larger than the received enlarging range is displayed, and a frame representing the received enlarging range is displayed in the displayed image of the predetermined size.

Here, an image can be outputted through a screen operated by a computer, or a printer, etc. The target image to be enlarged can be obtained by being photographed by a camera, an external image data, or an image data stored in various type of memory device.

In addition, the part of the target image can be designated from the various portion of the target image.

The operator may be a person who controls an image display method of the image display program in accordance with the present invention.

In the embodiments of the present invention, the enlargement range and the enlargement ratio may be various magnitudes. For example, the enlargement ratio of the part of the target image may be set to be larger than the size of high precision image display area.

Even when the enlargement ratio is set to be very high, the zoom in boundary can be easily controlled by the operator by displaying the image selected on the high precision image display area and the enlargement setting sub-window, and the enlarged image can be displayed on the zoomed-in image display area based on the enlargement designated position and the designated enlargement ratio.

In addition, a plurality of windows for enlargement setting are displayed for the zoom-in boundaries, which are displayed small when the enlargement ratio is set to be high such that the operator controls the zoom-in boundary having a size bigger than a predetermined size displayed on one or a plurality of screens and can easily change the enlargement position and the enlargement ratio.

Here, in order to display an image of an image which is larger than a designated size of the enlargement range, a middle boundary is used. The enlargement ratio of the middle boundary is not only a reference for use of the enlargement setting sub-window but also the enlargement ratio for an image to be displayed on the enlargement setting sub-window.

The enlargement ratio of the middle boundary may be set by various schemes. For example, it is possible to set up in advance a predetermined enlargement ratio as the enlargement ratio of the middle boundary, and it is also possible to set an enlargement ratio calculated based on a size of the original image as the enlargement ratio of the middle boundary.

The image display program in accordance with the exemplary embodiment of the present invention provides following functions for enlargingly displaying a designated image, an enlargement range designating function, and an enlargement range designation display function for displaying an image range to be enlarged.

Here, the image display method and the image display device in accordance with the exemplary embodiment of the present invention provide an enlargement ratio determining function for determining a designated enlargement ratio by using the enlargement range designating function, a second enlargement on a determined result of an enlargement ratio determination, range designating function for designating a determined result based on the enlargement ratio determining function.

Thereby, the operator may easily designate an enlargement range of an image to be enlarged.

In accordance with an aspect of the present invention, there is provided a program, stored on a storage medium, to be executed by a computer having an image display apparatus, the program, when executed, causing the computer to perform the functions of: (a) displaying an initial image on the display apparatus; (b) receiving a zoom-in boundary designated on the displayed initial image, the part of the displayed initial image surrounded by the zoom-in boundary being a target image to be enlarged; (c) detecting a size of the zoom-in boundary; (d) comparing the detected size of the zoom-in boundary with a reference size; (e) if the detected size of the zoom-in boundary is smaller than the reference size, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and (f) if the detected size of the zoom-in boundary is greater than or equal to the reference size, enlarging the target image to display the enlarged target image on the image display apparatus.

Further, in accordance with another aspect of the present invention, there is provided an image displaying method comprising the steps of: (a) displaying an initial image on the display apparatus; (b) receiving a zoom-in boundary designated on the displayed initial image, the part of the displayed initial image surrounded by the zoom-in boundary being a target image to be enlarged; (c) detecting a size of the zoom-in boundary; (d) comparing the detected size of the zoom-in boundary with a reference size; (e) if the detected size of the zoom-in boundary is smaller than the reference size, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and (f) if the detected size of the zoom-in boundary is greater than or equal to the reference size, enlarging the target image to display the enlarged target image on the image display apparatus.

In the above aspects of the present invention, if the detected size of the zoom-in boundary is smaller than the reference size, the functions or steps of (b) to (e) may be repeated with respect to the enlarged redefined image.

Further, in accordance with still another aspect of the present invention, there is provided a program, stored on a storage medium, to be executed by a computer having an image display apparatus, the program, when executed, causing the computer to perform the functions of: (a) displaying an initial image on the display apparatus; (b) receiving a zoom-in boundary designated on the displayed initial image, the part of the displayed initial image surrounded by the zoom-in boundary being a target image to be enlarged; (c) detecting an enlargement ratio of the zoom-in boundary; (d) comparing the enlargement ratio of the zoom-in boundary with a reference ratio; (e) if the detected enlargement ratio of the zoom-in boundary is greater than the reference ratio, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and (f) if the detected enlargement ratio of the zoom-in boundary is smaller than or equal to the reference ratio, enlarging the target image to display the enlarged target image on the image display apparatus.

Herein, if the detected enlargement ratio of the zoom-in boundary is greater than the reference ratio, the functions of (b) to (e) may be repeated with respect to the enlarged redefined image.

In the above aspects of the present invention, the initial image and the enlarged target image may be displayed on fixed non-overlapping image areas on the display apparatus, respectively. Herein, the enlarged redefined image may be displayed in a movable sub-window on the display apparatus.

### BRIEF DESCRIPTION OF THE DRAWINGS

The above and other objects and features of the present invention will become apparent from the following description of preferred embodiments, given in conjunction with the accompanying drawings, in which:

FIG. 1 is a schematic diagram of an exemplary structure of an image display device in accordance with an exemplary embodiment of the present invention;

FIG. 2 shows an example of the image display device;

FIG. 3 describes an example for an operation button (i.e., enlargement display position moving button) of the image display device;

FIG. 4 offers a diagram illustrating an operating button (i.e., enlargement ratio changing button) of the image display device;

FIG. 5 is a diagram showing an operation button (i.e., enlargement ratio changing pop-up menu) of the image display device;

FIG. 6 illustrates an exemplary display screen of the image display device;

FIG. 7 describes an example of relations among images in accordance with an exemplary embodiment of the present invention;

FIG. 8 depicts another example of relations among images in accordance with an exemplary embodiment of the present invention;

FIG. 9 illustrates a sequence of an enlargement display process in accordance with an exemplary embodiment of the present invention;

FIG. 10 provides an example of a display screen of the image display device;

FIG. 11 shows a security system in accordance with an exemplary embodiment of the present invention;

FIG. 12 is a diagram showing an exemplary display screen of the image display device;

FIG. 13 illustrates another exemplary display screen of the image display device; and

FIG. 14 depicts still another exemplary display screen of the image display device.

### DETAILED DESCRIPTION OF THE PREFERRED EMBODIMENTS

Referring to the drawings, embodiments of the present invention will be described in detail.

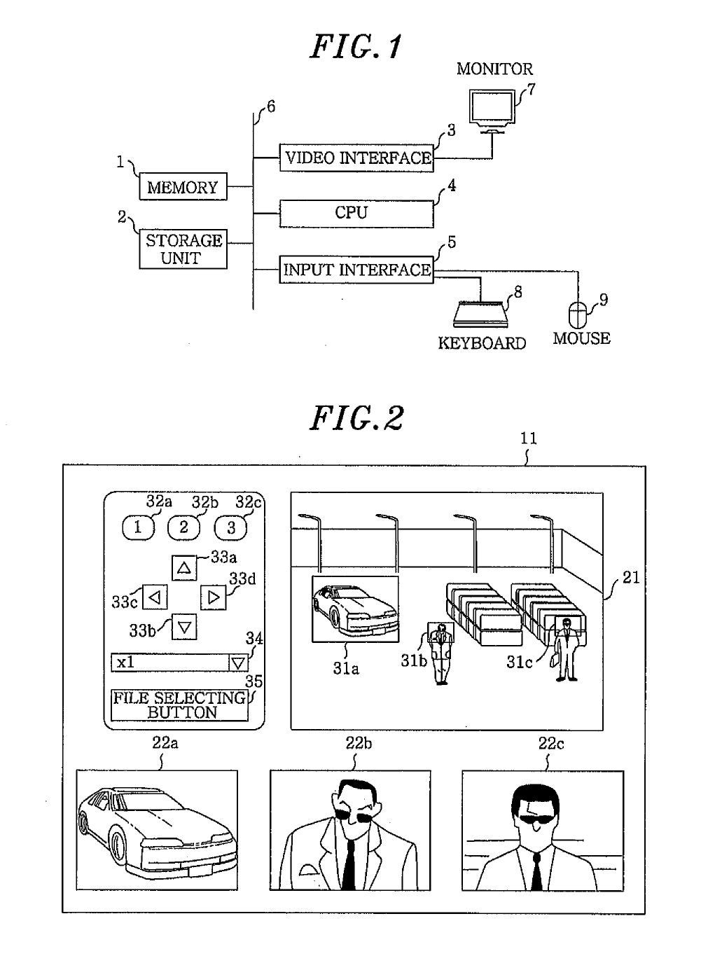

FIG. 1 shows a schematic diagram for a hardware structure of an image display device performing an image display method in accordance with an embodiment of the present invention.

The image display device in accordance with an exemplary embodiment of the present invention is configured to use a personal computer (PC). For example, the image display device includes a memory 1 for memorizing data such as a read only memory (ROM) or a random access memory (RAM), a storage unit 2 for storing data such as a hard disc, a video interface 3 for relaying image data, a central processing unit (CPU) 4 for various data processing and controlling, an input interface 5 for relaying input data, a bus 6 for transmitting data, a monitor 7 for displaying image data, input device 8 for inputting data such as a keyboard, and a pointing device 9 for inputting data such as a mouse.

The memory 1, the storage unit 2, the video interface 3, the CPU 4, and the input interface 5 are connected through the bus 6. The monitor 7 is connected to the bus 6 through the video interface 3. The input device 8 and the pointing device 9 are connected to the bus 6 through the input interface 5. The image display device in accordance with the embodiment of the present invention reads and processes image data. Here the image data may be recorded with a camera and stored in the memory 1 or the storage unit 2, or may be obtained from an external device such as a network device or removable media.

Hereinafter, an image enlargement (zoom-in) and reduction (zoom-out) method will be described in detail. As one of the image enlargement and reduction methods, a method named as an affine transformation has been used widely. The affine transformation is given by Equation 1. In accordance with the affine transformation, a pixel (x1, y1) is transformed into a pixel (x2, y2).

Equation 2 shows a condition under which an enlargement and a reduction are performed. Here, Sx, and Sy respectively represent enlargement ratios of x-axis direction and y-axis direction. The image will be enlarged when Sx or Sy is bigger than 1.0, and the image will be reduced when Sx or Sy is smaller than 1.0.

$$( \begin{matrix}x 2 \\ y 2\end{matrix} ) = ( \begin{matrix}a 11 & a 12 \\ a 21 & a 22\end{matrix} ) ( \begin{matrix}x 1 \\ y 1\end{matrix} ) + ( \begin{matrix}a 13 \\ a 23\end{matrix} ) \qquad ( Equation 1 )$$

a11=Sx

a12=0

a13=0

a21=0

a22=Sy

a23=0 (Equation 2)

Hereinafter, as an example of an operation performed by the image display device in accordance with an exemplary embodiment of the present invention, a process for a partial image enlargement will be described in detail. The image display device in accordance with the exemplary embodiment of the present invention can perform an image display and an operation manipulated by an operator. FIG. 2 shows an example of an operating screen 11 of the image display device.

The operating screen 11 which is displayed on a displaying part of the monitor includes a high precision image display area 21, three zoomed-in image display areas 22a, 22b, and 22c, and additionally includes three enlargement display selecting buttons 32a, 32b, 32c, four enlarging display position moving buttons 33a, 33b, 33c, and 33d, an enlargement ratio changing button 34, and a file selecting button 35.

From a file selecting dialog obtained by clicking the file selecting button 35 (e.g., left mouse button), the operator can select an image to be displayed on the high precision image display area 21. Referring to FIG. 2, three zoomed in boundaries (frames) 31a, 31b, and 31c are displayed on the operating screen 11 based on an enlargement position and an enlargement ratio set by referring to the high precision image display area 21. Partial images contained in the zoom-in boundaries 31a, 31b, and 31c are displayed on the zoomed-in image display areas 22a, 22b, and 22c, respectively.

Here, the zoom-in boundary 31a, the enlargement display selecting button 32a, and the zoomed-in image display area 22a correspond to each other. Likewise, the zoom-in boundary 31b, the enlargement display selecting button 32b, and the zoomed-in image display area 22b correspond to each other. Further, the zoom-in boundary 31c, the enlargement display selecting button 32c, and the zoomed-in image display area 22c correspond to each other.

In accordance with the exemplary embodiment of the present invention, when using a high precision image having larger number of pixels than displaying parts that display the high precision images, a thinning out method is utilized to reduce the whole image and the reduced image is displayed on the high precision image display area 21. A high precision image, compared with a standard image of low image quality, is of superior precision, image quality, number of pixels, number of gradations for one pixel, and compression ratio, and the like. Accordingly, it is possible to display an image of higher precision than a standard image, even when it is displayed on any of the zoomed-in image display areas 22a, 22b, and 22c by setting up a high enlargement ratio.

Next, a position changing scheme for a partial image enlarged on any of the zoomed-in image display areas 22a, 22b, and 22c will be described.

When clicking one of the enlargement display selecting buttons 32a, 32b, and 32c, one of the zoom-in boundaries 31a, 31b, and 31c corresponding to the clicked enlargement display selecting button is activated.

Afterward, the operator can perform any operation on the activated zoom-in boundary among the zoom-in boundaries 31a, 31b, and 31c, wherein the activated zoom-in boundary can be distinguished from the others by color. In other words, by changing the color of the activated zoom-in boundary to make it different from those of the others that are not activated among the zoom-in boundaries 31a, 31b, and 31c, the activated one and the others are distinguished.

For example, when clicking the enlargement display selecting button 32a, the color of the corresponding zoom-in boundary 31a turns into red and the zoom-in boundary 31a is activated so that the operator can perform any operation on the zoom-in boundary. At this moment, the other zoom-in boundaries 31b and 31c which are not selected remain black, and the operator cannot perform any operation on them. When the enlargement display selecting button 32a is clicked again while it is activated, or when any of the other enlargement display selecting buttons 31b, and 31c is clicked, the activation of the zoom-in boundary 31a is canceled such that the color of the zoom-in boundary 31a becomes black and the operator cannot perform any operation on it.

The zoom-in boundaries 31a, 31b, and 31c are moved by operating the enlargement display position moving buttons 33a, 33b, 33c, and 33d. To be more specific, the zoom-in boundary is moved by one dot upward when the enlargement display position moving button 33a is clicked, by one dot downward when the enlargement display position moving button 33b is clicked, by one dot leftward when the enlargement display position moving button 33c is clicked, and by one dot rightward when the enlargement display position moving button 33d is clicked. The zoom-in boundary is moved in a corresponding direction continuously when one of the enlargement display position moving buttons 33a, 33b, 33c, and 33d is continuously pressed.

In addition, it is also possible that directional keys provided on a key board may be configured to perform the same function as the enlargement display position moving buttons.

When the zoom-in boundaries 31a, 31b, and 31c are moved, corresponding respective partial images on the zoomed-in image display areas 22a, 22b, and 22c are renewed. Next, a fine control for the partial images displayed on the zoomed-in image display areas 22a, 22b, and 22c will be described in detail.

By clicking one of the activated zoomed-in image display areas 22a, 22b, and 22c, the partial image displayed thereon is activated such that the position thereof can be finely controlled.

For example, by clicking an arbitrary point of the zoomed-in image display area 22a, the color of an outer frame of the zoomed-in image display area 22a becomes red, and the position of the image can be finely controlled. At this moment, no fine position controls for the zoomed-in image display areas 22b and 22c can be performed. However, it is automatically cancelled when one of the enlargement display selecting buttons 32a, 32b, and 32c is selected.

In the state in which the zoomed-in image display area 22a is selected, when clicking arbitrary place of the operating screen 11 other than the zoomed-in image display area 22a and the enlargement display selecting button 32a, the selection of the zoomed-in image display area 22a is cancelled so that the red color of the outer frame disappears and no fine control of the position of the image can be carried out.

The fine control of the position is performed by using the enlargement display position moving buttons 33a, 33b, 33c, and 33d. The position is moved by one dot upward when the enlargement display position moving button 33a is clicked, by one dot downward when the enlargement display position moving button 33b is clicked, by one dot leftward when the enlargement display position moving button 33c is clicked and by one dot rightward when the enlargement display position moving button 33d is clicked. The zoom-in boundary is moved continuously in a corresponding direction when one of the enlargement display position moving buttons 33a, 33b, 33c, and 33d is continuously pressed.

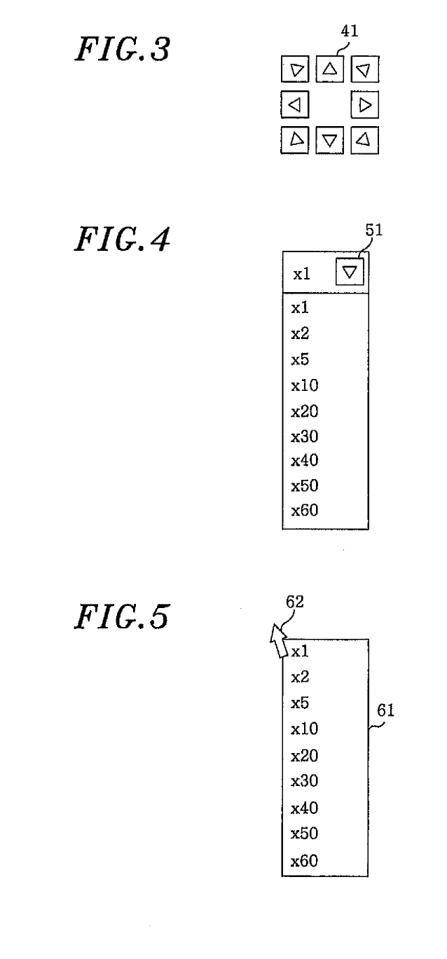

In accordance with another exemplary embodiment of the present invention, instead of the enlargement display position moving buttons 33a, 33b, 33c, and 33d in four directions as shown FIG. 2, an enlargement display position moving button 41 in eight directions as shown in FIG. 3 can be also provided. Accordingly, it becomes possible to move zoom-in boundaries 31a, 31b, and 31c diagonally.

In addition, in accordance with still another exemplary embodiment of the present invention, instead of providing the enlargement display position moving buttons as shown in FIG. 2 and FIG. 3, it can be also provided that, when clicking an arbitrary point in the high precision image display area 21 or in the zoomed-in image display areas 22a, 22b, and 22c, the location clicked will be indicated on the high precision image display area 21, and the images on the zoomed-in image display areas 22a, 22b, and 22c will be renewed such that the clicked point becomes to be a center.

Moreover, in accordance with still another exemplary embodiment of the present invention, by dragging a mouse, (e.g., moving the mouse while pressing down a left mouse button), the partial image enlarged in the high precision image can be continuously moved in accordance with a trace of the mouse.

Next, a method for changing an enlargement ratio for a partial image to be enlarged will be described in detail.

A change of the enlargement ratio is performed by the enlargement ratio changing button 34 shown in FIG. 2. The change in the enlargement ratio for a selected image can be made when one of the zoom-in boundaries 31a, 31b, and 31c is selected, or one of the zoomed-in image display areas 22a, 22b, and 22c is selected.

When clicking reverse triangle button located on a right side of the enlargement ratio changing button 34, a list of possible enlargement ratios is indicated. The enlargement ratio can be changed by selecting one of the possible enlargement ratios in the list. FIG. 4 illustrates the list of the possible enlargement ratio shown when an enlargement ratio changing button 51 is clicked, which corresponds to the enlargement ratio changing button 34 shown in FIG. 2.

Sizes of the zoom-in boundaries 31a, 31b, and 31c of the selected images and ranges of the partial images of the high precision images displayed on the zoomed-in image display areas 22a, 22b, and 22c are changed without changing centers thereof, when the enlargement ratio is changed by using the enlarging ratio changing button 34.

In accordance with the embodiment of the present invention, in the case that the sizes of the zoomed-in image display areas 22a, 22b, and 22c are constant, the sizes of the zoom-in boundaries 31a, 31b, and 31c and the enlargement ratio are determined by a single combinatoric selection.

In accordance with another exemplary embodiment of the present invention, the enlargements ratio of the partial image may be changed as follows.
An enlargement ratio changing pop-up menu 61 as shown in FIG. 5 appears, when one of the zoom-in boundaries 31a, 31b, and 31c is selected and a right mouse button is clicked while a mouse cursor is in the high precision image display area 21, or when one of the zoomed-in image display areas 22a, 22b, and 22c is selected and the right mouse button is clicked while the mouse cursor is in the zoomed-in image display areas 22a, 22b, and 22c.

In the enlargement ratio changing pop-up menu 61, all predetermined enlargement ratios are indicated. The enlargement ratio is selected by using a pointer 62, and then ranges of the zoom-in boundaries 31a, 31b, and 31c and the partial images are renewed. The renewed partial images are displayed on the zoomed-in image display areas 22a, 22b, and 22c.

In accordance with still another exemplary embodiment of the present invention, the enlargement ratio of the partial image may be changed as follows.

An enlargement ratio is changed, when one of the zoom-in boundaries 31a, 31b, and 31c is selected and a mouse wheel is rotated while the mouse cursor is in the high precision image display area 21, or when one of the zoomed-in image display areas 22a, 22b, and 22c is selected and the mouse wheel is rotated while the mouse cursor is in the zoomed-in image display areas 22a, 22b, and 22c.

In this case, the zoom-in boundaries 31a, 31b, and 31c and the partial images are renewed with images enlarged by one step larger enlargement ratio than the present one in the predetermined enlargement ratio list when the mouse wheel is rotated forward by one step.

The zoom-in boundaries 31a, 31b, and 31c and the partial images are renewed with images enlarged by one step smaller enlargement ratio than the present one in the predetermined enlargement ratio list when the mouse wheel is rotated backward by one step. The partial images are enlarged in accordance with the selected enlargement ratio and are displayed on the zoomed-in image display areas 22a, 22b, and 22c.

There is another method different from the above described method using the predetermined enlargement ratio list. It is also possible to change the enlargement ratio in accordance with a rotation angle of a mouse wheel. That is, a minimum rotation angle of the wheel (e.g., 15 degrees) is set to be a step, and the enlargement ratio is changed by 5 percent per one step.

For example, by rotating the wheel by 6 steps (e.g., 90 degrees) forward, the enlargement ratio is increased by 30 percent. By rotating the wheel by 10 steps (e.g., 150 degrees) backward, the enlargement ratio is decreased by 50 percent.

In addition, in accordance with still another embodiment of the present invention, the enlargement ratio can be changed by varying the sizes of the zoom-in boundaries 31a, 31b, and 31c by a drag and drop of the mouse. In this case, the enlargement ratio is determined by the size of the frame after the drag and drop. In other words, the sizes of the zoom-in boundaries 31a, 31b, and 31c can be enlarged or reduced by a mouse dragging, and the enlargement ratio may be determined based on the respective changed sizes of the zoom-in boundaries 31a, 31b, and 31c.

Next will be described a display method of the zoom-in boundaries 31a, 31b, and 31c indicating positions of the partial images.

In accordance with an exemplary embodiment of the present invention, outer frame lines of the zoom-in boundaries 31a, 31b, and 31c flicker when the sizes of the zoom-in boundaries 31a, 31b, and 31c become smaller than a predetermined size because the enlargement ratio is changed to be higher than a predetermined ratio. In other words, magnitudes of the changed enlargement ratio and the predetermined enlargement ratio are compared with each other, and then a process for flickering is performed.

The zoom-in boundaries 31a, 31b, and 31c for indicating the positions of the partial images are displayed on the high precision image display area 21. For example, when the enlargement ratio of the zoom-in boundary 31a is set to be lower than the predetermined enlargement ratio, the outer line of the zoom-in boundary 31a flickers to be in a flicker-off state. However, the other zoom-in boundaries 31b and 31c, whose enlargement ratios are set to be higher than the predetermined enlargement ratio, do not flicker to be in a flicker-off state.

Thus, the zoom-in boundaries 31b and 31c, which are displayed to be smaller due to respective high enlargement ratios, are clearly expressed because the zoom-in boundaries 31b and 31c are in flicker-on state. Accordingly, the operator may confirm and change the location to be enlarged by manipulating the zoom-in boundaries 31b and 31c.

In accordance with another exemplary embodiment of the present invention, instead of making the zoom-in boundaries flicker based on the sizes of the frames, any of the zoom-in boundaries 31a, 31b and 31c, which is selected by using the enlargement display selecting buttons 32a, 32b and 32c to be activated for changing the enlargement location, can be displayed to be flickering, and thereby, the enlargement location may be clearly indicated by the zoom-in boundaries 31a, 31b, and 31c which are currently activated to be enlarged.

Next, a method for displaying the zoom-in boundaries 31a, 31b, and 31c indicating the position of the partial image to be enlarged, and a position changing method for partial image thereof will be described in detail.

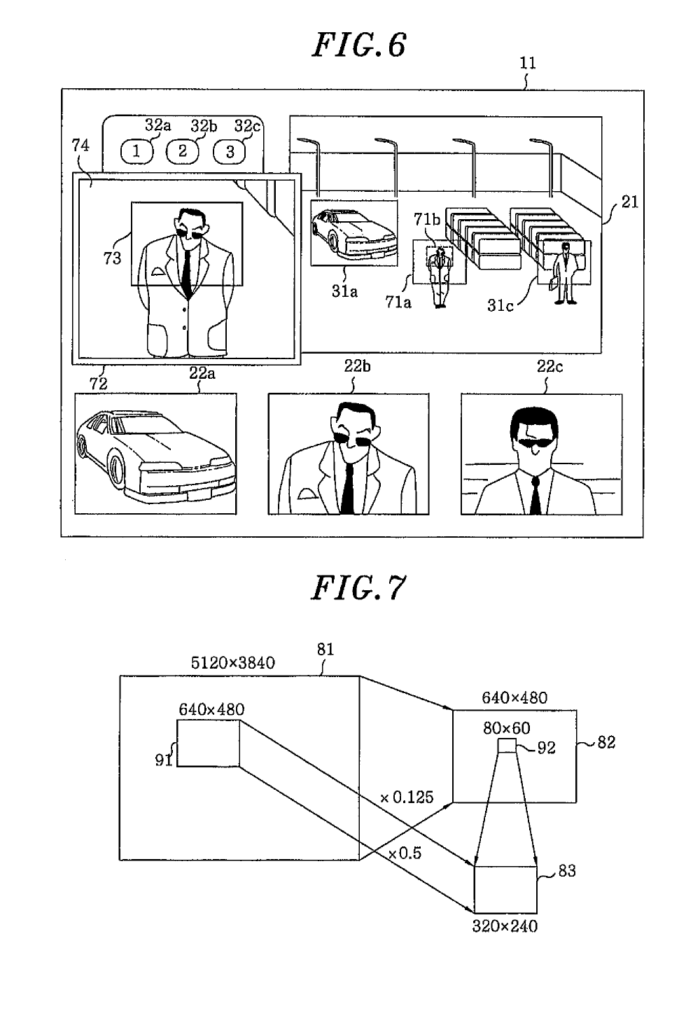

FIG. 6 shows another example for the operating screen 11 of the image display device in accordance with an exemplary embodiment of the present invention. In FIG. 6, same reference characters as those in FIG. 2 are used for same elements, and a middle boundary 71a is displayed in place of the zoom-in boundary 31b shown FIG. 2.

The enlargement ratio of the zoom-in boundary 31a is equal to the size of the zoomed-in image display area 22a divided by the size of the zoom-in boundary 31a. Further, the size of the zoomed-in image display area 22a is a constant. Therefore, the enlargement ratio of the zoom-in boundary 31a is reversely proportional to the size thereof. Accordingly, comparing the enlargement ratio of the zoom-in boundary 31a with a reference ratio is equivalent to comparing the size of the zoom-in boundary 31a with a reference size, wherein the reference size is a size at which the enlargement ratio becomes equal to the reference ratio. The same is also applied to other zoom-in boundaries (e.g., the zoom-in boundaries 31b and 31c).

In accordance with the embodiment of the present invention, after an initial image is displayed on the high precision image display area 21 that is fixed, a zoom-in boundary is received, and the size (or the enlargement ratio) of the zoom-in boundary is detected. Herein, the zoom-in boundary is designated on the displayed initial image, and surrounds a target image to be enlarged. Then, the detected size (or the enlargement ratio) is compared with a reference size (or a reference ratio).

If the detected size is smaller than the reference size, a middle boundary the defines a redefined image is set on the initial image, and is enlarged on an enlargement setting sub-window that is movable; otherwise, the target image is enlarged on the zoomed-in image display area the is fixed. Herein, the redefined image includes the entire part of the target image and a part of the initial image outside of the zoom-in boundary. Further, these processes may be repeated with respect to the enlarged redefined image if the detected size is smaller than the reference size.

More specifically, when a zoom-in boundary (which is, in this example, the zoom-in boundary 31b) is newly received or the size (or the enlargement ratio) of the zoom-in boundary 31b is newly set, the detected or received size (or the received enlargement ratio) of the zoom-in boundary 31b is compared with the reference size (or the reference ratio).

Then, if the detected size of the zoom-in boundary 31b is smaller than the reference size (or if the set enlargement ratio of the zoom-in boundary 31b is higher than the reference ratio), a redefined image enclosed by the middle boundary 71a of the reference size is displayed instead of the original target image enclosed by the zoom-in boundary 31b; otherwise, the original target image is enlarged to be displayed on the zoomed-in image display area 22b. Hereinafter, a zoom-in boundary whose size is set smaller than the reference size will be referred to as a detailed boundary. As shown in FIG. 61 the redefined image includes the entire part of the original target image in the detailed boundary and a part of the image outside of the detailed boundary.

In FIG. 6, the middle boundary 71a is displayed in place of the zoom-in boundary 31b. For better understanding, a detailed boundary 71b of the present case is expressed by a dotted line. In the present embodiment, the detailed boundary 71b is not actually displayed in the high precision image display area 21. However, it is also possible to display the detailed boundary 71b in the high precision image display area 21.

As shown in FIG. 6, an enlargement setting sub-window 72 that is movable is newly displayed on the operating screen 11 when the middle boundary 71a is displayed. Here, the enlargement setting sub-window 72 is displayed or not depending on, for example, the result of comparison between a newly set enlargement ratio and the reference ratio (or comparison between a newly set size and the reference size). More specifically, if the enlargement ratio is set to be greater than the reference ratio (or if the size is set to be smaller than the reference size), the enlargement setting sub-window 72 is displayed; otherwise, the enlargement setting sub-window 72 is not displayed. The redefined image in the middle boundary is enlarged to be displayed in the enlargement setting sub-window 72 if the following two conditions are met: (i) one of the zoom-in boundaries 31a, 31b, 31c is selected to be activated by manipulating the enlargement display selecting buttons 32a, 32b and 32c; and (ii) the middle boundary is displayed instead of the selected zoom-in boundary 31a, 31b or 31c (i.e., the enlargement ratio is set to be greater than the reference ratio or the size is set to be smaller than the reference size).

In the illustrated example shown in FIG. 6, the enlargement display selecting button 32b is selected. Accordingly, a redefined image 74 in the middle boundary 71a is enlarged to be displayed on the enlargement setting sub-window 72, wherein an additional zoom-in boundary 73 corresponding to the detailed boundary 71b is displayed with a relative position same as that of the detailed boundary 71b.

The zoom-in boundary 73 shown in the enlargement setting sub-window 72 is larger in size than the detailed boundary 71b displayed in the high precision image display area 21, because the image displayed on the enlargement setting sub-window 72 is an image which is enlarged from a part of the whole image displayed on the high precision image display area 21. Here, the operator can adjust the enlargement position and the enlargement ratio for the image by referring to the enlargement setting sub-window 72. Detailed processes for such adjustments are same as those in the above-described enlargement position and ratio adjustment method carried out for the high precision image display area 21.

The enlargement setting sub-window 72 is erased from the operating screen 11 when the enlargement ratio (or the size) of the zoom-in boundary 31b that has been the detailed boundary is changed to be lower than (or greater than) the reference ratio (or the reference size) or the detailed boundary that has been activated is canceled.

In addition, depending on the number of pixels of the high precision image, two or more enlargement setting sub-windows containing the middle boundaries may be displayed. In this manner, the position and enlargement ratio of an image to be enlarged can be adjusted more easily by referring to a proper-sized image.

Further, after the redefined image (which is a first redefined image) in the middle boundary 71a is displayed as an enlarged redefined image on the enlargement setting sub-window 72, an adjusted zoom-in boundary for the further enlargement may be set and displayed in the enlarged redefined image, wherein the adjusted zoom-in boundary defines a second redefined image.

In this case, the enlargement ratio (or the size) of the adjusted zoom-in boundary is compared to the reference ratio (or the reference size).

If the enlargement ratio is greater than the reference ratio (or the size is smaller than the reference size), the second redefined image is enlarged to be displayed in a second enlargement setting sub-window. These processes may be further repeated with respect to the second redefined image.

However, if the enlargement ratio is smaller than or equal to the reference ratio (or the size is larger than or equal to the reference size), the first redefined image is enlarged to be displayed on the zoomed-in image display area 22b.

By repeating the above procedures, a specific part of an image can be repeatedly enlarged to be displayed in a subsequent enlargement setting sub-window by referring to a subsequent middle boundary. In this manner, a target image to be enlarged can be set easily and precisely.

As described above, one or more screens (such as the enlargement setting sub-windows 72) used for the image enlargement are displayed on behalf of the zoom-in boundary 31a, 31b or 31c displayed in a small size when the enlargement ratio is set to be high. Thus, the operator adjusts the zoom-in boundary by referring to one or more images larger than the reference size displayed on one or more screens (i.e., the enlargement setting sub-windows), so that the adjustment of the enlargement position and the enlargement ratio can be performed more easily and precisely.

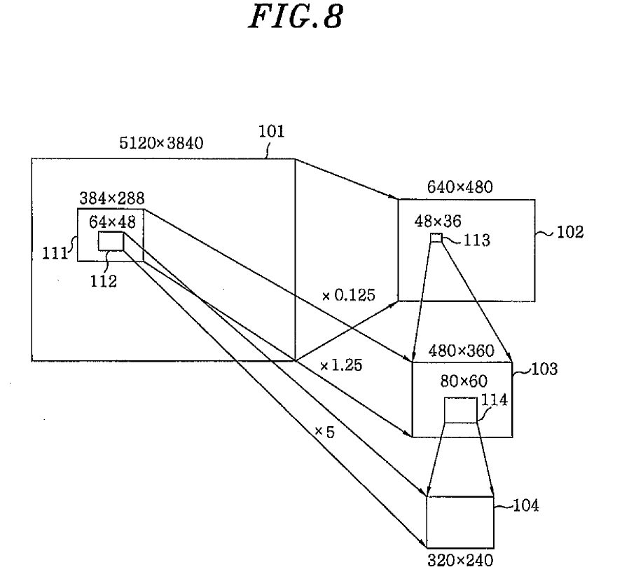

Next, referring to FIG. 7 and FIG. 8, a relation among an image of original data (in this embodiment, a high precision image), a thinned out image displayed on the high precision image display area 21, an image displayed on the enlargement setting sub-window 72, images displayed on the zoomed-in image display areas 22a, 22b, and 22c will be described in detail with reference to the number of pixels and the enlargement ratio. Referring to FIG. 7, a relation among an image selected by the file selecting button 35 (image of the original data), the image displayed on the high precision image display area 21, and the images displayed on the zoomed-in image display areas 22a, 22b, and 22c will be described.

In the operating screen 11 of the image display device in accordance with an exemplary embodiment of the present invention, FIG. 7 describes the relation among an image 81 selected by the file selecting button 35 (image of the original data, referred to be the original image), an image 82 displayed on the high precision image display area 21 (referred to be a whole image), an images 83 displayed on the zoomed-in image display areas 22a, 22b, and 22c (referred to be an enlarged image). In this example, a case in which the image 82 displayed on the high precision image display area 21 is enlarged by four times and is displayed on the zoomed-in image display area 22b will be described.

In addition, the operating screen 11 in accordance with this embodiment has three zoomed-in image display areas 22a, 22b, and 22c. However, here, for the better understanding and convenience, only an image displayed on the zoomed-in image display area 22b, which is one of the zoomed-in image display area, will be described.

For example, the original image 81 selected by the file selecting button 35 is an image of a width 5120 pixels and a height 3840 pixels. In addition, the whole image 82 displayed on the high precision image display area 21 is an image of width 640 pixels and height 480 pixels, and the enlarged image 83 displayed on the zoomed-in image display area 22b is an image of width 320 pixels and height 240 pixels.

The original image 81 cannot be displayed as it is on the high precision image display area 21, because the original image 81 has a larger size than the whole image 82. Therefore, the whole image 82 is obtained by reducing the original image 81 by using the affine transformation (Sx=640/5120=0.125, Sy=480/3840=0.125) expressed in Equation 1.

Next, based on a designated enlargement ratio (in this case, four times) and a designated position (cx, cy) obtained by various operations of the operator, the zoom-in boundary 92 corresponding to the zoom-in boundary 31b shown in FIG. 2 is determined. Here, the enlargement frame 92 should have a width of 80 (=320/4) pixels and a height of 60 (=240/4) pixels in order to be displayed with an enlargement ratio of four times because the enlarged image 83 displayed on zoomed-in image display area 22b should have a width 320 pixels and a height 240 pixels. Therefore, zoom-in boundary 92 becomes a rectangular area having a range of (cx−40, cy−30)˜(cx+40, cy+30) on the whole image 82.

Next, referring to the zoom-in boundary 92, the enlarged image 83 is generated from the original image 81.

An area indicated by the zoom-in boundary 92 becomes a rectangular area 91 (corresponding to the zoom-in boundary 92) having range of ((cx−40/0.125, cy−30/0.125)˜(cx+40/0.125, cy+30/0.125)=(cx/0.125−320, cy/0.125−240)˜(cx/0.125+320, cy/0.125+240) on the original image 81, because the whole image 82 is generated by multiplying 0.125 to the original image 81.

Here, since the area 91 on the original image 81 has a width 640 pixels and a height 480 pixels, it cannot be displayed on the zoomed-in image display area 22b as it is as the enlarged image 83.

Therefore, by using the affine transformation (Sx=320/640=0.5, Sy=240/480=0.5) expressed in Equation 1, the size of area 91 on the original image 81 is transformed, and then the enlarged image 83 may be obtained.

As described above, the image selected by the file selecting button 35 can be displayed on the zoomed-in image display area 22b based on the designated position and the designated enlargement ratio on the high precision image display area 21.

Referring to FIG. 8, exemplary operations for a case where the enlargement ratio is higher than the reference ratio will be described.

In this example, the reference ratio is assumed to be 10 times. The enlargement setting sub-window 72 shown in FIG. 6 will be displayed when the enlarged image is to be displayed on the zoomed-in image display area 22b with an enlargement ratio bigger than 10 times.

FIG. 8 shows relationships among an image 101 selected by the file selecting button 35 (i.e., an image of the original data, which is an original image 101), an image 102 displayed on the high precision image display area 21 (i.e., whole image 102), an image 103 displayed on the enlargement setting sub-window 72 (i.e., middle image 103), and an image 104 displayed on the zoomed-in image display area 22b (i.e., enlarged image 104), in operating screen 11 of the image display device. In this embodiment, the image displayed on the high precision image display area 21 will be enlarged 40 times, and will be displayed on the zoomed-in image display area 22b.

In accordance with the embodiment of the present invention, though the operating screen 11 includes three zoomed-in image display areas 22a, 22b, and 22c, for better understanding and convenience, only the zoomed-in image display area 22b will be described here.

The original image 101 selected by the file selecting button 35 is an image a width 5120 pixels and a height 3840 pixels. The whole image 102 displayed on the high precision image display area 21 is an image of a width 640 pixels and a height 480 pixels. The middle image 103 displayed on the enlargement setting sub-window 72 is an image of a width 480 pixels and a height 360 pixels. The enlarged image 104 displayed on the zoomed-in image display area 22b is an image of a width 320 pixels and a height 240 pixels. Since the original image 101 is larger in size than the whole image 102, it cannot be displayed as it is on the high precision image display area 21 as the whole image 102. Therefore, the whole image 102 is obtained from the original image 101 by using the affine transformation (Sx=640/5120−0.125, Sy=480/3840=0.125) expressed in Equation 1.

The middle boundary 113 corresponding to the middle boundary 71a shown in FIG. 6 is determined based on the designated enlargement ratio (in this case, 40 times) and the designated position (cx1, cy1) in the high precision image display area 21 determined by the various operator controls. Here, since the enlargement ratio is larger than 10 times, the enlargement setting sub-window 72 is displayed. In accordance with the embodiment of the present invention, an image, which is 10 times of the whole image 102 displayed on the high precision image display area 21, is displayed as the middle image 103 in the enlargement setting sub-window 72. Here, a middle boundary 113 becomes a size of a width 48 (=480/10) pixels and a height 36 (=360/10) pixels in order to display with the 10 times enlargement ratio, because the middle image 103 displayed in the enlargement setting sub-window 72 is an image of a width 480 pixels and a height 360 pixels.

Therefore, the middle boundary 113 becomes a rectangular area having a range of (cx1−24, cy1−18)˜(cx1+24, cy1+18) in the whole image 21. Next, based on the middle boundary 113, the middle image 103 is generated from the original image 101. The area indicated by the middle boundary 113 corresponds to a rectangular area 111 having a range of ((cx1−24)/0.125, (cy1−18)/0.125)˜((cx1+24)/0.125, (cy1+18)/0.125)=(cx1/0.125-192, cy1/0.125−144)˜(cx1/0.125+192, cy1/0.125+144) in the original image 101, because the whole image 102 is obtained by multiplying the original image 101 by 0.125.

Here, the area 111 in the original image 101 cannot be fitted to be displayed on to the a frame of the enlargement setting sub-window 72 as an middle image 103, because the area 111 has a size of a width 384 pixels and height 288 pixels. Therefore, the middle image 103 is obtained by transforming the area 111 in the original image 101 by using the affine transformation (Sx=480/384=1.25, Sy=360/288=1.25) as expressed in Equation 1.

Next, a zoom-in boundary 114 corresponding to an adjusted zoom-in boundary 73 shown in FIG. 6 is determined based on a designated position (cx2, cy2) on the enlargement setting sub-window 72 by the various operator controls.

Here, an image whose size is 4 (=40/10) times as large as that of the middle image 103 is displayed on the zoomed-in image display area 22b, because the middle image 103, whose size is 10 times as large as that of the whole image 102 displayed on the high precision image display area 21, is displayed in the enlargement setting sub-window 72.

The size of the zoom-in boundary 114 is set to be a width 80=320/4 pixels and a height 60 (=240/4) pixels in order to be displayed with an enlargement ratio of 4 times, because the enlarged image 104 displayed on the zoomed-in image display area 22b has a size of a width 320 pixels and a height 240 pixels. Therefore, the zoom-in boundary 114 becomes a rectangular area having a range of (cx2−40, cy2−30)˜(cx2+40, cy2+30) in the middle image 103. Then, the enlarged image 104 is generated from the original image 101 with reference to the zoom-in boundary 114.

The area indicated by the zoom-in boundary 114 corresponds to a rectangular area 112 having a range of (cx1/0.125−192+(cx2−40)/1.25, cy1/0.125−144+(cy2−30)/1.25)˜(cx1/0.125−192+(cx2+40)/1.25, cy1/0.125−144+(cy2+30)/1.25)=(cx1/0.125−192+cx2/1.25−32, cy1/0.125−144+cy2/1.25−24)˜(cx1/0.125−192+cx2/1.25+32, cy1/0.125−144+cy2/1.25+24) in the original image 101, because the middle image 103 is obtained by multiplying the original image 101 with 1.25.

Here, the area 112 in the original image 101 cannot be fitted to be displayed on the a frame of the zoomed-in image display area 22b as the enlarged image 104, because the area 112 has size of a width 64 pixels and a height 48 pixels. Therefore, the enlarged image 104 is obtained by transforming the area 112 in the original image 101 by using the affine transformation (Sx=320/64=5, Sy=240/48=5) as expressed in Equation 1. When the enlargement ratio becomes 40 times, the zoom-in boundary corresponding to the detailed boundary 71b on the high precision image display area 21 becomes a size of a width 8 (−320/40) pixels and a height 6 (=240/40) pixels. This is too small for the operator to precisely adjust the enlargement position and ratio precisely by referring to the zoom-in boundary. However, in accordance with the exemplary embodiment of the present invention, the image selected by the file selecting button 35 can be enlarged and displayed on the zoomed-in image display area 22b by using the high precision image display area 21 without using the enlargement setting sub-window 72. Thereby, above described problem may be solved.

In other words, in accordance with the exemplary embodiment of the present invention, the zoom-in boundary can be easily adjusted by the operator even when the size of the zoom-in boundary is excessively small (i.e., the enlargement ratio is set to be excessively high), because the original target image selected from the high precision image display area 21 by the file selecting button 35 is changed to a redefined image including more image around the original target image, and then enlarged to be displayed in the enlargement setting sub-window 72. Thus, the target image can be easily adjusted by referring to the image displayed on the enlargement setting sub-window 72, and the enlarged target image can be properly displayed on the zoomed-in image display area 22b based on the selected enlargement position and ratio.

Though, in this exemplary embodiment of the present invention, it is described that an image to be enlarged and displayed is selected by using the file selecting button 35. However, in accordance with another embodiment, an image to be enlarged and displayed can be also collected and selected from a camera or a photographing device externally connected to the image display device, and an equivalent advantage can be obtained.

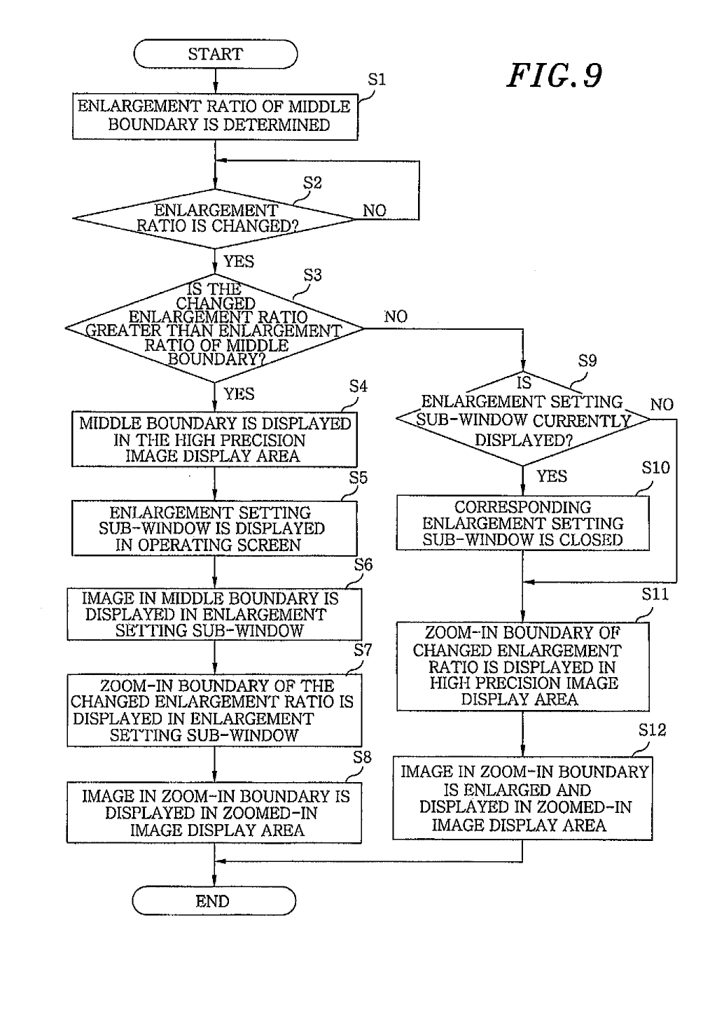

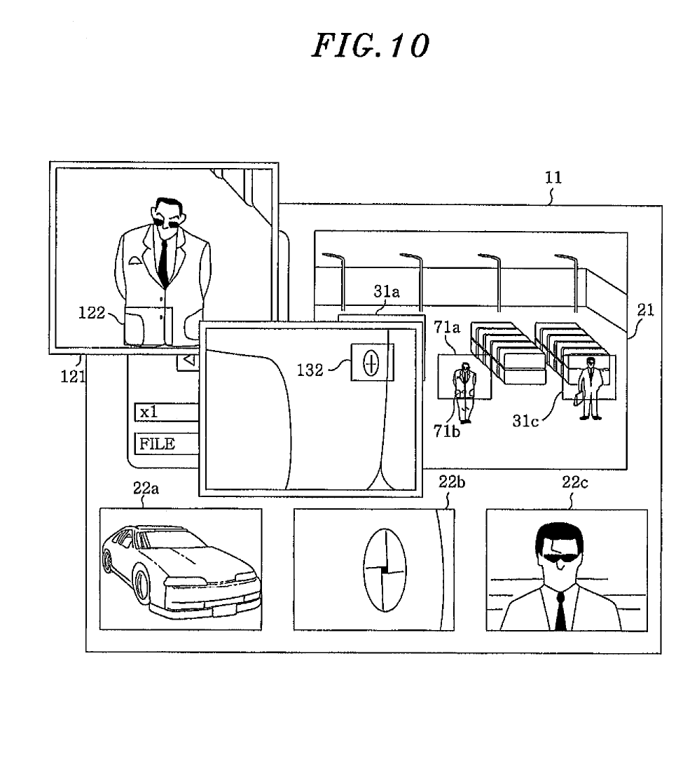

Referring to FIG. 2, FIG. 6, and FIG. 9, an enlargement display method for changing an enlargement ratio by the operator will be described in detail. FIG. 9 illustrates a process for realizing the enlargement display method. First, the enlargement ratio of the middle boundary 71a (which is equal to the reference ratio) is set by the operator for the image display device, in step S1. Here, in accordance with the exemplary embodiment of the present invention, the enlargement ratio of the middle boundary 71a is not only the reference ratio for determining whether or not the enlargement setting sub-window 72 is to be displayed but also the ratio of enlarging the image to be displayed on the enlargement setting sub-window 72.

The enlargement ratio of the middle boundary 71a may be set by various schemes. For example, it is possible to set up in advance the reference ratio as the enlargement ratio of the middle boundary 71a, and it is also possible to set an enlargement ratio calculated based on a size of the original image as the enlargement ratio of the middle boundary 71a. In this embodiment, the enlargement ratio of the middle boundary 71a is set to be 10 times.

In accordance with the image display device of the exemplary embodiment, the enlargement ratios of the zoom-in boundaries 31a, 31b, and 31c (which are, in this embodiment, the enlargement ratios of the zoomed-in image display areas 22a, 22b, and 22c) are checked constantly or periodically, so that it is detected whether or not they are changed by the operator (step S2).

When one of the enlargement ratios of the zoom-in boundaries 31a, 31b and 31c is changed, it is determined whether the enlargement ratio of the zoom-in boundary 31b changed by the operator is greater than the enlargement ratio of the middle boundary 71a or not, in step S3.

Here, a case where the enlargement ratio of the zoom-in boundary changed by the operator is greater than the enlargement ratio of the middle boundary 71a will be described. It is assumed that the operator changes the enlargement ratio of the zoom-in boundary 31b (middle boundary 71a) to be 40 times.

The middle boundary 71a is displayed on the high precision image display area 21, in step S4. In accordance with the exemplary embodiment of the present invention, the middle boundary 71a of a size that renders its enlargement ratio to be 10 (as set in step 1) is displayed on the high precision image display area 21. In this case, a zoom-in boundary of a size corresponding to the enlargement ratio of 40, which is the enlargement ratio set by the operator, becomes the detailed boundary 71b shown in FIG. 6. However, in accordance with the exemplary embodiment of the present invention, the detailed boundary 71b is not actually displayed.

Then, the enlargement setting sub-window 72 is opened and displayed on the operating screen 11, in step S5. The enlargement setting sub-window 72 may be moved to a desired position by the operator's control. Further, the image in the middle boundary 71a is displayed in the enlargement setting sub-window 72, in step S6. In accordance with the exemplary embodiment of the present invention, the image in the middle boundary 71a is extracted from the original image, and is fitted to the size of the enlargement setting sub-window 72. Then, the image 74 fitted by enlargement or reduction is displayed on the enlargement setting sub-window 72.

An adjusted zoom-in boundary 73 corresponding to the detailed boundary 71b whose enlargement ratio has been changed is displayed within the image 74 displayed on the enlargement setting sub-window 72, in step S7.

In accordance with the exemplary embodiment of the present invention, the adjusted zoom-in boundary 73 of the image of 10 times enlargement ratio corresponds to 40 times enlargement ratio (changed enlargement ratio), because the image 74 displayed on the enlargement setting sub-window 72 is an image enlarged 10 times from its original image, which is the enlargement ratio of the middle boundary 71a. The adjusted zoom-in boundary 73 can be moved to a desired position on the enlargement setting sub-window 72 by the operator's control.

The image in the adjusted zoom-in boundary 73 corresponding to the detailed boundary 71b is displayed in the zoomed-in image display area 22b, in step S8. In accordance with the exemplary embodiment of the present invention, the image not in the original image but in the adjusted zoom-in boundary 73 displayed on the enlargement setting sub-window 72 is extracted and fitted to the size of the zoomed-in image display area 22b. Then, the image fitted by enlargement or reduction is displayed on the zoomed-in image display area 22b.

Next, a case in which the enlargement ratios of the zoom-in boundaries 31a, 31b, and 31c changed by the operator are smaller than the enlargement ratio of the middle boundary 71a will be described. In this exemplary embodiment, it is assumed that the operator changes the enlargement ratio of the zoom-in boundary 31a to be 5 times.

It is determined whether the enlargement setting sub-window 72 is currently displayed or not, in step S9.

When the enlargement setting sub-window 72 is currently displayed, the corresponding enlargement setting sub-window 72 is closed, in step S10. However, this step is not performed when the enlargement setting sub-window 72 is not currently displayed.

The zoom-in boundary 31a of the changed enlargement ratio is displayed on the high precision image display area 21, in step S11.

An image in the zoom-in boundary 31a is enlarged and displayed on the zoomed-in image display area 22a, in step S12. In accordance with the exemplary embodiment of the present invention, the image not in the original image but in the zoom-in boundary 31a displayed on the high precision image display area 21 is extracted and fitted to the size of the zoomed-in image display area 31a. Then, the image fitted by enlargement or reduction is displayed on the zoomed-in image display area 31a.

In accordance with the exemplary embodiment of the present invention, the image in the middle boundary 71a is extracted and displayed on the enlargement setting sub-window 72, in step S6. However, in accordance with another exemplary embodiment of the present invention, a range of the image displayed on the enlargement setting sub-window 72 is not limited to the range of the middle boundary 71a (the range determined based on the enlargement ratio of the middle boundary 71a, in step S1).

The image to be displayed on the enlargement setting sub-window 72 may be provided based on the size of the detailed boundary 71b (enlargement ratios of the zoom-in boundaries 31a, 31b, and 31c changed by the operator), as, for example, displaying an image which is 300 percent of the detailed boundary 71b.

Next, another example of the operating screen of the image display device will be described for the enlargement of a partial image.

FIG. 10 shows another example of the operating screen 11 of the image display device for the enlargement of a partial image. In FIG. 10, same numerals are used for same elements as those shown in FIG. 2 and FIG. 6. When the enlargement ratio of the zoom-in boundary 31b (corresponding to the detailed boundary 71b) is designated to be higher than a reference ratio, a zoom-in boundary (a second middle boundary) 122 is displayed in the enlargement setting sub-window 121 (i.e., equivalent to the enlargement setting sub-window 72 shown in FIG. 6), in which an image in the middle boundary (a first middle boundary) 71a displayed on the high precision image display area 21 is enlarged and displayed.

In addition, the enlargement setting sub-window 131, in which the image in the second middle boundary 122 is enlarged and displayed, is displayed. An enlarged image in the zoom-in boundary 132, which is enlarged based on a designated position and a designated enlargement ratio, in the enlargement setting sub-window 131, is displayed on the zoomed-in image display area 22b.

For example, when setting the enlargement ratios of the zoom-in boundaries 31a, 31b, and 31c to be very high, the detailed boundary 71b becomes too small in the high precision image display area 21. Consequently, it becomes difficult to exactly designate an enlargement position and enlargement ratio by using the detailed boundary 71b in the high precision image display area 21 (in this embodiment, not to be displayed).

For this reason, as to FIG. 6, one enlargement setting sub-window 72 is displayed, and the enlargement position and the enlargement ratio are designated by using the adjusted zoom-in boundary 73 corresponding to the detailed boundary 71b. Moreover, in FIG. 10, a plurality of enlargement setting sub-windows 121 and 131 are sequentially displayed. Thereby, the enlargement position and the enlargement ratio may be properly designated by using the middle boundary 122 of the initial enlargement setting sub-window 121 and the zoom-in boundary 132 (corresponding to the detailed boundary 71b) of the final enlargement setting sub-window 131.

As described above, in accordance with the exemplary embodiment of the present invention, higher enlargement ratio can be designated by displaying a plurality of screens (e.g., enlargement setting sub-windows 121, 131) for setting up the enlargement ratio. Accordingly, a problem that the enlargement ratio cannot be set to be very high on the original image can be solved, and precision of the image may be improved.

Although, in this embodiment, the enlarged images are displayed on the zoomed-in image display areas 22a, 22b, and 22c. However, in accordance with another embodiment, the enlarged images can be exported to other output device such as a printer. In this case, the enlarged images may be outputted to a printer and be displayed on the zoomed-in image display areas 22a, 22b, and 22c simultaneously, or it may be outputted only to the printer.

To be more specific, while the zoomed-in image display areas 22a, 22b, and 22c are not provided on the operating screen 11, the image data set by the range of the high precision image display area 21 or the enlargement setting sub-windows 72, 121, and 131 may be outputted to a printer connected with a terminal (in this embodiment, the image display device).

Moreover, in accordance with the embodiment shown in FIG. 6 and FIG. 10, both of the high precision image display area 21 and the enlargement setting sub-windows 72 and 121 are displayed. However, in accordance with another embodiment, only one of these may be displayed. To be more specific, in the operating screen 11, when the enlargement setting sub-windows 72 and 121 are displayed, the high precision image display area 21 may be erased, so that the enlargement setting sub-windows 72 and 121 may replace the high precision image display area 21.

In addition, in accordance with the embodiment shown in FIG. 10, a plurality of enlargement setting sub-windows 121 and 131 are displayed in the same screen. However, in accordance with another embodiment, a plurality of enlargement setting sub-windows 121 and 131 may be changed to be displayed by stages as the enlargement ratio increases.

It is also possible to increase the number of overlapped portions of windows such that it looks like as if there are many windows to be changed. In the FIG. 6 and FIG. 10, the windows are overlapped with each other, and the window of the highest enlargement ratio is arranged to be displayed on the top.

Hereinafter, a security system, to which the image display method and the image display device in accordance with the present invention may be applied, will be described in detail.

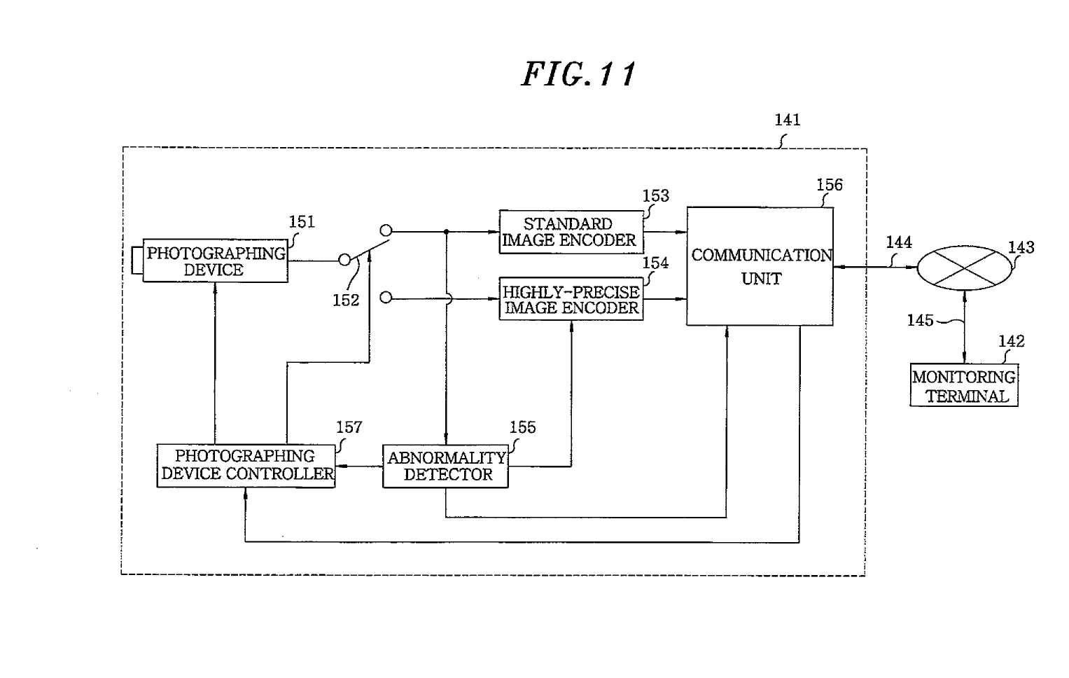

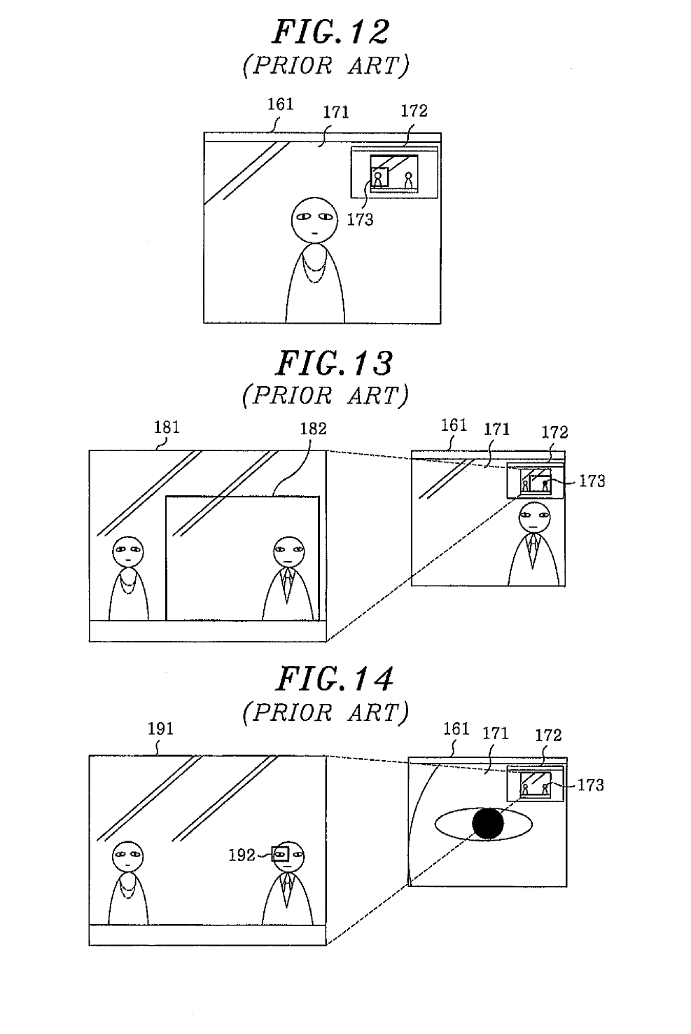

FIG. 11 illustrates a schematic block diagram of a security system in accordance with an exemplary embodiment of the present invention.

The security system in accordance with an embodiment of the present invention includes a monitoring device 141, a monitor terminal 142, a network 143, an access line 144 connecting the monitoring device 141 and the network 143, and an access line 145 connecting the monitor terminal 142 and the network 143. Here, the network 143 may be an analog phone network, ISDN (Integrated Services Digital Network), digital exclusive line network, or Internet.

The monitoring device 141 includes a photographing device 151 including a TV and a camera, and the like, a video switch 152 including a converting switch, a standard image encoder 153, a high precision image encoder 154, an abnormality detector 155, a communications unit 156, and a photographing device controller 157.

An operation of the monitoring device 141 in accordance with an embodiment of the present invention will be described.

The photographing device 151 photographs an area to be monitored (monitoring area), and outputs an image signal obtained by the photographing to the video switch 152. The photographing device 151 is operated either in a standard image mode for photographing a standard image or in a high precision image mode for photographing a high precision image, selected by a control signal input from the photographing device controller 157. In accordance with the exemplary embodiment of the present invention, an image of width 640 pixels×height 480 pixels, taking 30 frames per a second, is used as the standard image, and an image of width 5120 pixels×height 3840 pixels, taking 7.5 frames per a second, is used as the high precision image.

The video switch 152 converts an input unit of the video signal outputted from the photographing device 151 by a control signal inputted from the photographing device controller 157. In accordance with the exemplary embodiment of the present invention, the video switch 152 converts a signal path in order that an output end of the photographing device 151, an input end of the standard image encoder 153, and an input end of the abnormality detector 155 are coupled together when the standard image mode is set in the photographing device 151, and converts the signal path in order that the output end of the photographing device 151, and an input end of the high precision image encoder 154 are coupled together when the high precision image mode is set in the photographing device 151.

The standard image outputted from the photographing device 151 is provided to the standard image encoder 153 and the abnormality detector 155, when the photographing device 151 photographs the standard image. The high precision image outputted from the photographing device 151 is provided to the high precision image encoder 154, when the photographing device 151 photographs the high precision image.

The standard image encoder 153 encodes a video signal of the standard image inputted from the photographing device 151 through the video switch 152 in accordance with a predetermined moving picture encoding scheme and outputs the encoded data to the communication unit 156. Here, as the moving picture encoding scheme, various schemes such as MPEG-1, MPEG-2, MPEG-4, and motion JPEG may be used.

The abnormality detector 155 processes the video signal of the standard image inputted from the photographing device 151 through the video switch 152 by using a difference method and the like, and detects some abnormality in the monitoring area such as a stranger.

In accordance with the exemplary embodiment of the present invention, if the abnormality detector 155 determines that a body, which should be detected, is present by using the difference method and the like, it detects the body as an abnormality (e.g., a stranger).

If the abnormality detector 155 detects an abnormality, it transmits a request signal for obtaining a high precision image to the photographing device controller 157. In order to notify the abnormality such as a stranger to the monitor terminal 142, the abnormality detector 155 transmits a detected result such as a position information of the stranger, a temporal information of detected time, and a number of abnormality detected to the communications unit 156, and also transmits an information about an image range in which the stranger is present.

Here, the image range, in which the abnormality (e.g., the stranger) is detected, for example, is calculated based on a changing image area obtained from two-valued images produced by the abnormality detector 155. To be more specific, firstly, an exterior rectangular area is reckoned in correspondence with an image portion to be a changing image area. Next, an image range is obtained by extending the reckoned exterior rectangular area vertically and horizontally by a predetermined number of pixels, and the obtained image range is set to be an image range where the abnormality (e.g., stranger) is present.

Here, the number of pixels used in extending the reckoned exterior rectangular area vertically and horizontally, for example, may be 30 pixels. The reason, why extending the exterior rectangular area by the predetermined number of pixels, is that not only the image in which the abnormality (e.g., stranger) exists but also an image of surroundings thereof are included in a screen, so that it is easy to understand where the abnormality (e.g., stranger) is detected and how a situation around the stranger is.

In this exemplary embodiment, the image range in which the abnormality is detected is determined based on the detecting result obtained by using the difference method and the like, but other various methods may be applied in determining the image range.

For example, a range in the image, in which the abnormality is detected, is reckoned based on an input from an extrinsic sensor such as a magnetic sensor, an infra-red sensor, a pressure sensor, a heat sensor, or a vibration sensor, which is installed in the monitoring area, and the reckoned range may be determined as the area in which abnormality is detected.

Here, when the abnormality detector 155 detects an abnormality based on the input from any of the extrinsic sensors, the abnormality detector 155 transmits the request signal for obtaining the high precision image to the photographing device controller 157, transmits a detected result including the position information of the abnormality, temporal information, information about a number of the detected abnormalities to the communications unit 156 in order to notify a presence of the detected abnormality to the monitor terminal 142, and transmits the information about determining the image range in which the abnormality is detected to the high precision image encoder 154 The high precision image encoder 154 encodes a video signal of the high precision image inputted from the photographing device 151 through the video switch 152 by using a predetermined still image encoding scheme, and transmits the encoded data to the communications unit 156. Here, for a still image encoding scheme, various schemes such as JPEG, JPEG2000 and the like may be utilized.

Also, the high precision image encoder 154 may cut out a partial image in the image range in which the abnormality (e.g., stranger) is detected from the high precision image, encode the partial image cut out, and transmit it to the communications unit 156. In this embodiment, the image range is received from the abnormality detector 155.

When a plurality of image ranges in which the abnormalities (e.g., strangers) are detected by the abnormality detector 155 is notified, it is possible that the high precision image encoder 154 cuts out a plurality of partial images corresponding to the plurality of image ranges, then encodes the respective plurality of partial images, and transmits them to the communications unit 156.

The high precision image encoder 154 records the detected result information on the abnormality inputted from the abnormality detector 155 on a header area of the encoded data, and transmits it to the communications unit 156.

In case of using JPEG for the encoding scheme, the information to be recorded on the header area may be recorded in accordance with Exif which is a standard for JPEG header area recording. In case of using JPEG2000 for the encoding scheme, a quantity of the data of the high precision image can be efficiently reduced by using a region of interest (ROI) function of JPEG2000. In accordance with the ROI function of JPEG2000, the image range in which the abnormality (e.g., stranger) is detected is compressed in a low compressing ratio, and the other image range is compressed in a high compressing ratio.

In addition, it is also possible to change a compressing ratio depending on a size of a detected changing area as an abnormality. Thereby, the compressing ratio is set to be high for a large size changing area, and is set to be low for a small size changing area. In other words, when the changing area is large, any detailed information is hardly necessary in order to watch the whole changing area. On the contrary, when the changing area is small, the detailed information is mostly necessary in order to investigate the detailed change of the changing area.

The communications unit 156 is connected to the network 143 through the access line 144, and may communicate with the monitor terminal 142 through the network 143, access line 144, and access line 145.

The communications unit 156 receives a moving picture encoding data outputted from the standard image encoder 153, a still image encoding data outputted from the high precision image encoder 154, and a detected result of the abnormality (e.g., stranger) outputted from the abnormality detector 155, and transmits them to the network 143 through the access line 144 in order to be inputted to the monitor terminal 142

In accordance with the exemplary embodiment of the present invention, the monitor terminal 142 transmits the request signal for obtaining the high precision image to the network 143 through the access line 145 in order to be inputted to the monitoring device 141.

The communications unit 156 receives the request signal from the network 143 through the access line 144, and transmits the received request signal to the photographing device controller 157.

When the photographing device controller 157 receives the request signal for obtaining the high precision image from the abnormality detector 155, or from the monitor terminal 142 through the communications unit 156, the photographing device controller 157 controls the photographing device 151 with a control signal to be set to operate in the high precision image mode for photographing a high precision image, while controlling the video switch 152 with a control signal to be switched to the high precision image encoder 154 simultaneously.

Consequently, when the abnormality detector 155 detects an abnormality (e.g. strange), or receives the request signal for obtaining the high precision image from the monitor terminal 142, the photographing device 151 may photograph the high precision image, and may output the high precision image to the high precision image encoder 154.

In other case, the photographing device controller 157 controls the photographing device 151 with a control signal to be set in the standard image mode for photographing the standard image, while controlling the video switch 152 with a control signal to be switched to the standard image encoder 153 and the abnormality detector 155 simultaneously.

Here, the image display method and the image display device in accordance with the exemplary embodiment of the present invention can be applied to the monitor terminal 142 of the security system shown in FIG. 11. For example, when the monitoring device 141 receives a request signal from the monitor terminal 142, or when an abnormality is detected by an image process of the monitoring device 141 or a sensor, the high precision image is photographed and transmitted to the monitor terminal 142 of the security system. At this moment, the image display method and the image display device in accordance with the embodiment of the present invention can be applied when the monitor terminal 142 displays an image obtained from the monitoring device 141 (in this case, the high precision image).

Although an area for displaying a standard image (moving picture) is not provided in the operating screen 11 of the image display device shown in FIG. 2, FIG. 6, and FIG. 10, in accordance with another embodiment, an area for displaying the standard image (moving picture) in the operating screen 11 of the monitor terminal 142 may be provided in accordance with an example in that the monitoring device 141 shown in FIG. 11 transmits the standard image (moving picture) to the monitor terminal 142.

As described above, the image display method and the image display device in accordance with the exemplary embodiment of the present invention provide a function for enlargingly displaying a designated image (in the exemplary embodiment of the present invention, a function related with the zoomed-in image display areas 22a, 22b, and 22c), an enlargement range designating function (in the exemplary embodiment of the present invention, a function for designating the enlargement position and the enlargement ratio in the high precision image display area 21), and an enlargement range designation display function for displaying an image range to be enlarged (in the exemplary embodiment of the present invention, a function related with the zoom-in boundaries 31a, 31b, and 31c in the high precision image display area 21).

Here, the image display method and the image display device in accordance with the exemplary embodiment of the present invention provide an enlargement ratio determining function for determining a designated enlargement ratio by using the enlargement range designating function, a second enlargement on a determined result of a enlargement ratio determination, (in this exemplary embodiment of the present invention, a function related with the zoom-in boundaries 73 and 132 in the enlargement setting sub-windows 72, 121, and 131), and a second enlargement range designating function for designating a determined result based on the enlargement ratio determining function (in this exemplary embodiment of the present invention, a function for designating the enlargement position and the enlargement ratio in the enlargement setting sub-windows 72, 121, and 131). Thereby, the operator may easily designate an enlargement range of an image to be enlarged.

In an image display method and an image display device in accordance with an exemplary embodiment of the present invention, the enlargement ratio determining function determines whether or not the designated enlargement ratio is to set to be higher than a reference ratio by using the enlargement range designating function. Accordingly, when the enlargement ratio is relatively high, the enlargement range may be designated in a size which is easy to be visually recognized.

In an image display method and an image display device in accordance with an exemplary embodiment of the present invention, a sub-screen display function provides a sub-screen display function for displaying a sub-screen (in the exemplary embodiment of the present invention, enlargement setting sub-window 72, 121, and 131) for an image of changed enlargement ratio based on a result of the enlargement ratio determining function. In addition, in accordance with a second enlargement range designating function, a new enlargement range may be designated by using the sub-screen, in other words, an image range to be enlarged may be displayed and designated in the sub-screen.

In accordance with an image display method and an image display device of an exemplary embodiment of the present invention, the enlargement range designating display function displays an enlargement range to be flickering in the whole screen by providing the sub-screen display function displaying a sub-screen (in the exemplary embodiment of the present invention, enlargement setting sub-window 72, 121, and 131). Accordingly, the enlargement range may be designated in the whole screen by making it be displayed by flickering. In addition, in accordance with the second enlargement range designating display function, the enlargement range may be designated by making it be displayed to be flickering in the sub-screen. Here, the flickering image range may be the range displayed on the zoomed-in image display areas 22a, 22b, and 22c, or the range displayed on the enlargement setting sub-windows 72, 121, and 131.

In accordance with another embodiment of the present invention, when the size of a frame becomes smaller than a reference size, instead of displaying the frame by making it flickering, a color of the frame may be changed into another color.

In accordance with an image display method and an image display device of an exemplary embodiment of the present invention, a plurality of screens for setting the enlargement range (in accordance with the exemplary embodiment of the present invention, enlargement setting sub-windows 72, 121, and 131) is displayed.

Therefore, even when the enlargement range becomes small by the operator's control, image display may be varied in accordance with the designated enlargement ratio such that the operator may control, confirm, and change the enlargement range easily.

For example, when a relatively high enlargement ratio is designated, it becomes difficult to confirm and change enlargement range by controlling the zoom-in boundary (in this embodiment of the present invention, zoom-in boundaries 31a, 31b, and 31c) displayed on the reduced whole image. However, the present invention may solve this problem.

Further, an image display method, an image display device, and an image display program in accordance with an exemplary embodiment of the present invention provide means for processing a target image of the designated enlargement range in the enlargement range designation target image on the high precision image display area 21, means for processing a display of a partial ranged image, which is defined by the middle boundaries 71a and 122, on the enlargement setting sub-windows 72, 122, and 131, means for designating the enlargement range of the partial ranged image by using the zoom-in boundaries 73 and 132 in the enlargement setting sub-windows 72 and 131, and means for processing a display of enlarged image by displaying the image of the enlargement range on the zoomed-in image display areas 22a, 22b, and 22c.

An image display method and an image display device in accordance with an embodiment of the present invention include means for receiving a designation of the operator for an enlargement range by using the zoom-in boundaries 31a, 31b, and 31c in the high precision image display area 21, means for detecting an enlargement ratio of the enlargement range, and means for comparing the enlargement ratio of the enlargement range with a predetermined value.

An image display method, an image display device and an image display program in accordance with an embodiment of the present invention include means for displaying an enlargement target image on the whole image on the high precision image display area 21 and the enlargement setting sub-windows 72, 121, and 131, means for receiving the enlargement range by using the frames 31a, 31b, 31c, 71a, 122, and 132 for the displayed image, means for detecting a size of the enlargement range, means for comparing the size of the enlargement range with a predetermined value, and means for displaying the frames 31a, 31b, 31c, 71a, 122, and 132 to be flickering when the enlargement range is relatively small.

The image display method, the image display device, and the security system in accordance with the exemplary embodiments of the present invention are not limited to the above described examples, but various modifications and equivalent arrangements can be applied.

The field of the present invention is not limited to the above described technical fields, but it can be applied to various technical fields.

The various processes performed by image display method, the image display device and the security system in accordance with the present invention may be performed by a processor executing a controlling program stored in a ROM (Read Only Memory), or may be performed by an individual device performing a function for realizing a corresponding process.

The present invention is also possible to be embodied as a code in a recording medium to be read by a computer. Examples of the recording medium to be read by a computer include a ROM, a RAM, a CD-ROM, a magnetic tape, a floppy disk, and the like. It can be also embodied in the form of a carrier wave (e.g., transmission through the Internet). In addition, the recording medium to be read by a computer may be dispersed in a computer system which is connected by a network, and may be stored and operated in the form of a code of a dispersed type to be read by a computer.

While the invention has been shown and described with respect to the preferred embodiments, it will be understood by those skilled in the art that various changes and modifications may be made without departing from the scope of the invention as defined in the following claims.

What is claimed is:

1. A program, stored on a storage medium, to be executed by a computer having an image display apparatus, the program, when executed, causing the computer to perform the functions of:
(a) displaying an initial image on the display apparatus;
(b) receiving a zoom-in boundary designated on the displayed initial image, the part of the displayed initial image surrounded by the zoom-in boundary being a target image to be enlarged;
(c) detecting a size of the zoom-in boundary;
(d) comparing the detected size of the zoom-in boundary with a reference size;
(e) if the detected size of the zoom-in boundary is smaller than the reference size, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and
(f) if the detected size of the zoom-in boundary is greater than or equal to the reference size, enlarging the target image to display the enlarged target image on the image display apparatus.

2. The program of claim 1, further performing the function of:
repeating, if the detected size of the zoom-in boundary is smaller than the reference size, the functions of (b) to (e) with respect to the enlarged redefined image.

3. The program of claim 2, wherein images displayed by the functions (a) and (e) are simultaneously displayed in a single screen or printed on a single sheet of paper,
wherein one of the images is displayed in a single screen or printed on a single sheet of paper by switching said one of the images; and
wherein one of the images is displayed in a single screen or printed on a single sheet of paper by choosing said one of the images as the one to be displayed.

4. The program of claim 1, wherein the initial image and the enlarged target image are displayed on fixed non-overlapping image areas on the display apparatus, respectively.

5. The program of claim 4, wherein the enlarged redefined image is displayed in a movable sub-window on the display apparatus.

6. The program of claim 1, wherein the storage medium constitutes an embedded part of the computer.

7. The storage medium containing the program of claim 1.

8. An image displaying method comprising the steps of:
(a) displaying an initial image on the display apparatus;
(b) receiving a zoom-in boundary designated on the displayed initial image, the part of the displayed initial image surrounded by the zoom-in boundary being a target image to be enlarged;
(c) detecting a size of the zoom-in boundary;
(d) comparing the detected size of the zoom-in boundary with a reference size;
(e) if the detected size of the zoom-in boundary is smaller than the reference size, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and
(f) if the detected size of the zoom-in boundary is greater than or equal to the reference size, enlarging the target image to display the enlarged target image on the image display apparatus.

9. The method of claim 8, further comprising the step of:
repeating, if the detected size of the zoom-in boundary is smaller than the reference size, the steps of (b) to (e) with respect to the enlarged redefined image.

10. The method of claim 9, wherein images displayed by the steps (a) and (e) are simultaneously displayed in a single screen or printed on a single sheet of paper,
wherein one of the images is displayed in a single screen or printed on a single sheet of paper by switching said one of the images; and
wherein one of the images is displayed in a single screen or printed on a single sheet of paper by choosing said one of the images as the one to be displayed.

11. The program of claim 8, wherein the initial image and the enlarged target image are displayed on fixed non-overlapping image areas on the display apparatus, respectively.

12. The program of claim 11, wherein the enlarged redefined image is displayed in a movable sub-window on the display apparatus.

13. A program, stored on a storage medium, to be executed by a computer having an image display apparatus, the program, when executed, causing the computer to perform the functions of:
(a) displaying an initial image on the display apparatus;
(b) receiving a zoom-in boundary designated on the displayed initial image, the part of the displayed initial image surrounded by the zoom-in boundary being a target image to be enlarged;
(c) detecting an enlargement ratio of the zoom-in boundary;
(d) comparing the enlargement ratio of the zoom-in boundary with a reference ratio;
(e) if the detected enlargement ratio of the zoom-in boundary is greater than the reference ratio, setting a middle boundary that defines a redefined image on the initial image, and enlarging the redefined image to display the enlarged redefined image on the display apparatus, wherein the redefined image includes the entire part of the target image and a part of the initial image outside of the zoom-in boundary; and
(f) if the detected enlargement ratio of the zoom-in boundary is smaller than or equal to the reference ratio, enlarging the target image to display the enlarged target image on the image display apparatus.

14. The program of claim 13, further performing the function of:
repeating, if the detected enlargement ratio of the zoom-in boundary is greater than the reference ratio, the functions of (b) to (e) with respect to the enlarged redefined image.

15. The program of claim 14, wherein images displayed by the functions (a) and (e) are simultaneously displayed in a single screen or printed on a single sheet of paper,
wherein one of the images is displayed in a single screen or printed on a single sheet of paper by switching said one of the images; and
wherein one of the images is displayed in a single screen or printed on a single sheet of paper by choosing said one of the images as the one to be displayed.

16. The program of claim 13, wherein the initial image and the enlarged target image are displayed on fixed non-overlapping image areas on the display apparatus, respectively.

17. The program of claim 16, wherein the enlarged redefined image is displayed in a movable sub-window on the display apparatus.
